(19) United States
(12) Patent Application Publication
(10) Pub. No.: US 2017/0208479 A1
(43) Pub. Date: Jul. 20, 2017

(54) RADIO BASE STATION AND RADIO COMMUNICATION METHOD

(71) Applicant: NTT DOCOMO, INC., Tokyo (JP)

(72) Inventors: Kazuaki Takeda, Tokyo (JP); Hideyuki Moroga, Tokyo (JP); Sadayuki Abeta, Tokyo (JP); Hideaki Takahashi, Tokyo (JP); Wuri Andarmawanti Hapsari, Tokyo (JP); Lan Chen, Tokyo (JP); Kengo Yagyu, Tokyo (JP)

(73) Assignee: NTT DOCOMO, INC., Tokyo (JP)

(21) Appl. No.: 15/328,092

(22) PCT Filed: Jul. 14, 2015
(86) PCT No.: PCT/JP2015/070113

§ 371 Date: Jan. 23, 2017

(30) Foreign Application Priority Data
Jul. 23, 2014 (JP) 2014-149889

(51) Int. Cl. H04W 16/28; H04W 72/04; H04W 16/32

(52) U.S. Cl. CPC H04W 16/28; H04W 16/32; H04W 72/0406; H04W 92/20

(57) ABSTRACT

The present invention is designed to apply beam forming control between base stations in accordance with traffic that varies over time or geographically. A radio base station can exchange control information with a neighbor radio base station via backhaul, and has a transmitting/receiving section that transmits and receives the control information through backhaul signaling, and a control section that controls the antenna beam pattern of one or both of the neighbor radio base station and the radio base station based on traffic information and information about antenna beam forming for the neighbor radio base station and the radio base station, which are included in the control information.

### TECHNICAL FIELD

The present invention relates to a radio base station and a radio communication method in a next-generation mobile communication system.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In LTE, as multiple access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink).

Successor systems of LTE have also been under study for the purpose of achieving further broadbandization and increased speed beyond LTE. Successor systems of LTE may be referred to as, for example, “LTE-advanced” or “LTE enhancement” (hereinafter referred to as “LTE-A”).

In the LTE-A system, a HetNet (Heterogeneous Network), in which small cells (for example, pico cells, femto cells and so on), each having a local coverage area of a radius of approximately several tens of meters, are formed inside a macro cell having a wide coverage area of a radius of approximately several kilometers, is under study (see non-patent literature 2). Also, in relationship to HetNets, a study is in progress to use carriers of different frequency bands between macro cell(s) (macro base station(s)) and small cell(s) (small base station(s)), in addition to carriers of the same frequency band.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: 3GPP TR 36.814 “E-UTRA Further Advancements for E-UTRA Physical Layer Aspects”

### SUMMARY OF INVENTION

### Technical Problem

Problems with small cells include the fact that their areas are not always optimal because the distribution of traffic becomes uneven due to the conditions in which the small cells are provided, uneven user distribution and so on. With conventional technology, backhaul signaling regarding antenna beam forming is not provided between base stations, and therefore beam forming control to take into account the beam patterns of neighbor base stations and so on is not possible.

The present invention has been made in view of the above, and it is therefore an object of the present invention to provide a radio base station and a radio communication method that can apply beam forming control between base stations in accordance with traffic that varies over time or geographically.

### Solution to Problem

The radio base station of the present invention is provided in the form of a radio base station that can exchange control information with a neighbor radio base station via backhaul, and this radio base station has a transmitting/receiving section that transmits and receives the control information through backhaul signaling, and a control section that controls the antenna beam pattern of one or both of the neighbor radio base station and the radio base station based on traffic information and information about antenna beam forming for the neighbor radio base station and the radio base station, which are included in the control information.

### Advantageous Effects of Invention

According to the present invention, beam forming control can be applied between base stations in accordance with traffic that varies over time or geographically.

### BRIEF DESCRIPTION OF DRAWINGS

FIG. 1 is a conceptual diagram of a HetNet;

FIG. 2 is a diagram to show an example of the placement of small cells;

FIG. 3 is a diagram to show an example of the placement of small cells;

FIG. 4 is a conceptual diagram of information about an antenna pattern;

FIG. 5 is a diagram to show an example of dual connectivity;

FIG. 6 provides diagrams to explain a first control method;

FIG. 7 provides diagrams to explain a second control method;

FIG. 8 provides diagrams to explain a third control method;

FIG. 9 provides diagrams to explain a fourth control method;

FIG. 10 provides diagrams to explain a fifth control method;

FIG. 11 is a diagram to show an example of a schematic structure of a radio communication system according to the present embodiment;

FIG. 12 is a diagram to show an example of an overall structure of a radio base station according to the present embodiment;

FIG. 13 is a diagram to show an example of a functional structure of a radio base station according to the present embodiment;

FIG. 14 is a diagram to show an example of an overall structure of a user terminal according to the present embodiment; and

FIG. 15 is a diagram to show an example of a functional structure of a user terminal according to the present embodiment.

### DESCRIPTION OF EMBODIMENTS

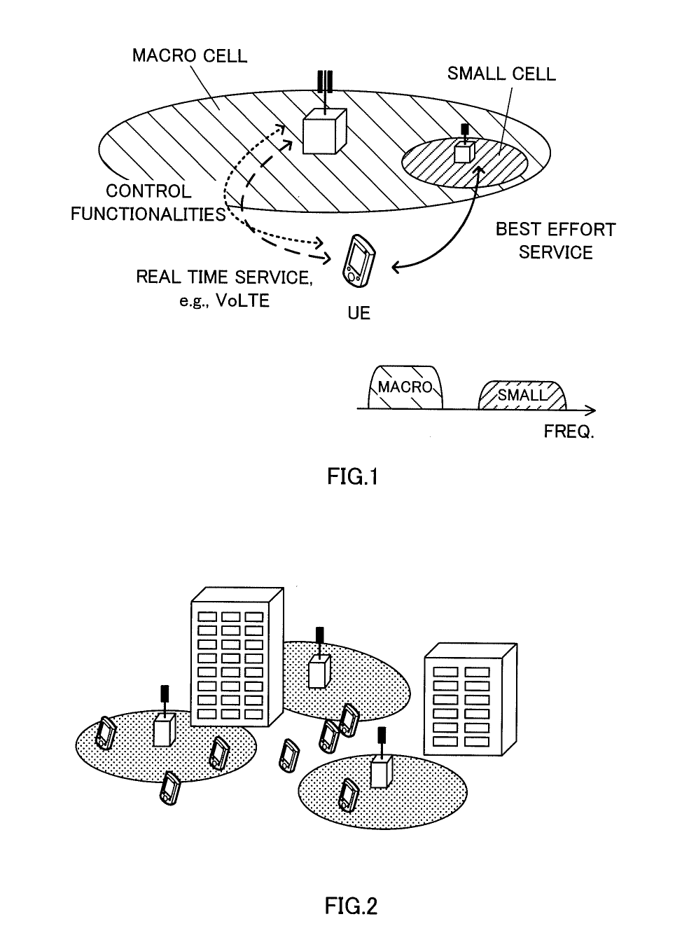

Now, an embodiment of the present invention will be described below in detail with reference to the accompanying drawings. FIG. 1 shows a conceptual diagram of a HetNet. As shown in FIG. 1, a HetNet refers to a radio communication system in which macro cells and small cells are placed to overlap each other geographically at least in part. A HetNet is comprised of a macro base station that forms a macro cell, a small base station that forms a small cell, and a user terminal that communicates with the macro base station and the small base station.

Generally speaking, the distribution of users and traffic are not fixed, but vary over time or between locations. Consequently, when many small cells are placed in a macro cell, the small cells may be placed in such a manner that their density and environment vary (sparse and dense) between locations. For example, it may be possible to raise the density of placing small cells in train stations, shopping malls and so on where many user terminals gather, and lower the density of placing small cells in places where user terminals do not gather. In this way, by densely placing small cells of low transmission power to cope with the surge of traffic, it is possible to achieve increased capacity.

In the HetNet shown in FIG. 1, a carrier of a relatively low frequency band—for example, 800 MHz, 2 GHz and so on—is used in the macro cell. The use of a low frequency band carrier allows the macro cell to assume a wide coverage easily, and operate in frequencies that allow connection to existing (Rel. 8 to 11) user terminals. By this means, the macro cell can cover a wide range area as a cell where all user terminals stay connected at all times.

In the HetNet shown in FIG. 1, a carrier of a relatively high frequency band—for example, 3.5 GHz—is used in the small cell. The use of a high frequency band carrier allows the small cell to use a wide band, which then enables efficient data off-loading in a best-effort model. Consequently, small cells are placed in a localized manner as user terminal off-loading cells in heavy-traffic areas.

In the HetNet shown in FIG. 1, the macro cell (macro base station) and the small cell (small base station) are connected via a backhaul link. Also, a plurality of small base stations, too, may be connected via a backhaul link as well. The connection between macro base stations and small base stations, or the connection between small base stations, may be established with wire connection using optical fiber, non-optical fiber (X2 interface) and so on.

In the macro cell layer, coverage and mobility are secured by establishing a control-plane connection. In the dense small cell layer, a user-plane connection, which is specifically for data, is established, so that capacity is increased, and the throughput of user terminal(s) is improved.

FIG. 2 is a diagram to show an example of the placement of small cells. Problems with small cells include the fact that their areas are not always optimal because the distribution of traffic becomes uneven due to the conditions in which the small cells are provided, uneven user distribution and so on. Interference cancellation based on tilt control is one measure against interference with existing technology. However, since cell planning such as for conventional macro cells cannot be applied to small cells due to restrictions on their placement and so on, tilt control is difficult with small cells placed unevenly.

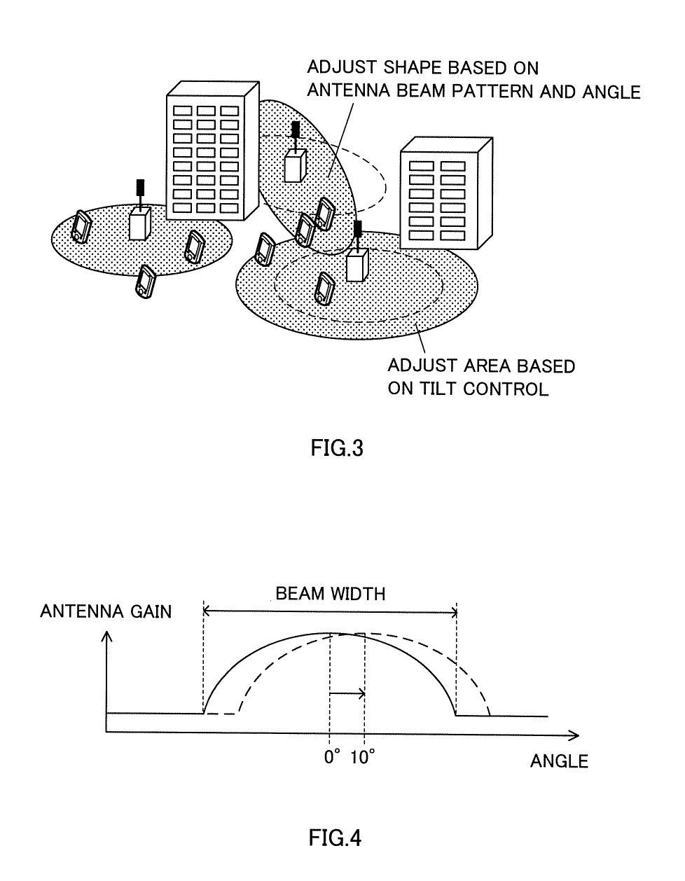

As shown in FIG. 3, it may be possible to form the areas of small cells adaptively by adjusting the areas using tilt control, in accordance with the distribution of traffic that changes with time, and, furthermore, by adjusting the shapes by controlling antenna beam patterns, angles and so on. With conventional technology, backhaul signaling regarding antenna beam forming is not provided between base stations, and therefore beam forming control to take into account the beam patterns of neighbor base stations and so on is not possible. The present inventors have come up with the idea of improving throughput by applying beam forming control between base stations in accordance with traffic that varies over time or geographically.

X2 signaling is used as a control signal that relates to adaptive area control. Alternatively, as control signals, the CPRI (Common Public Radio Interface)/OBSAI (Open Base Standard Architecture Initiative) or the OAM (Operation Administration and Maintenance) interface may be used. The CPRI is the interface specification that relates to the information to be sent in the front haul channel between RRH (Remote Radio Head) and BDE (Base station Digital processing Equipment). OBSAI is the interface specification between functional units inside a base station. For example, the interface specification between BDE and the line-side interface is an example. The OAM interface is the interface specification between maintenance/monitoring devices and network devices (base stations, core equipment, etc.).

Control signals that relate to adaptive area control include information about the antenna tilt, the horizontal beam, the transmission power, the antenna pattern, the rate of use of resources, the average throughput value and so on.

The information about the antenna tilt includes the absolute value of the angle information regarding the tilt, varying values which the tilt angle information might assume (+2 degrees, +1 degree, −2 degrees, and so on), and so on.

The information about the horizontal beam includes the absolute value of the angle information regarding the orientation of the beam, varying values which the angle information of the orientation of the beam might assume (+2 degrees, +1 degree, −2 degrees and so on), the absolute value of the angle information regarding the width of the beam, varying values which the angle information of the width of the beam might assume (+2 degrees, +1 degree, −2 degrees and so on), and so on.

The information about the antenna pattern is the combination of tilt information, information about the direction of the horizontal beam and the beam width, and information about the transmission power. As antenna pattern information, for example, a “pattern A” includes information such as a tilt angle of 45°, a beam direction of 120°, a beam width of 30°, and transmission power of 20 dBm. “Pattern A” is the only piece of information that is signaled, and the contents of this information are pre-configured in each base station.

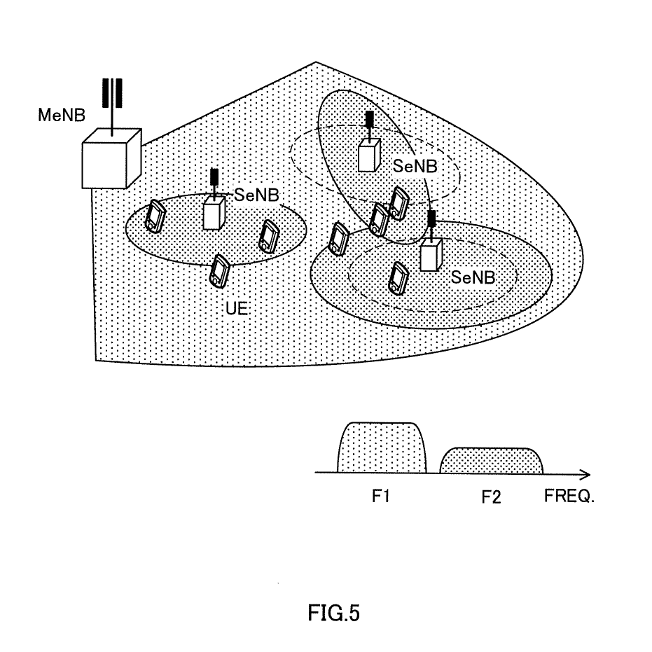

FIG. 4 is a conceptual diagram of information about an antenna pattern. As shown in FIG. 4, the angle to give the maximum antenna gain value varies depending on the tilt angle.

The average throughput value refers to the expected average throughput value or the past average throughput value.

Although control signals pertaining to adaptive area control are presumed to be given in base station-specific or cell-specific signaling, these signals may be linked with UE IDs and given in user terminal-specific signaling. For example, UE ID #1 may give a tilt angle of 20°, and UE ID #2 may give a tilt angle of 30°.

Furthermore, the granularity of the control signals may be determined in resource block (RB) or subband (SB) units. Also, subframes (SFs) and time information may be added. For example, subframes #0 to #4 may assume a tilt angle of 20°, and subframes #5 to #10 may assume a tilt angle of 30°.

Below, as shown in FIG. 5, control in the event of dual connectivity, in which different frequencies are bundled between different base stations (F1 and F2 in FIG. 5) will be discussed. When dual connectivity is employed, a plurality of schedulers are provided independently, and these multiple schedulers (for example, the scheduler provided in the macro cell base station MeNB and the schedulers provided in the small cell base stations SeNB) each control the scheduling of one or more cells they have control over.

The user terminals UE send measurement reports (RSRP (Reference Signal Received Power) and RSRQ (Reference Signal Received Quality)) of the small cells in the frequency band F2 to the macro cell base station MeNB based on inter-frequency or intra-frequency measurements.

(First Control Method)

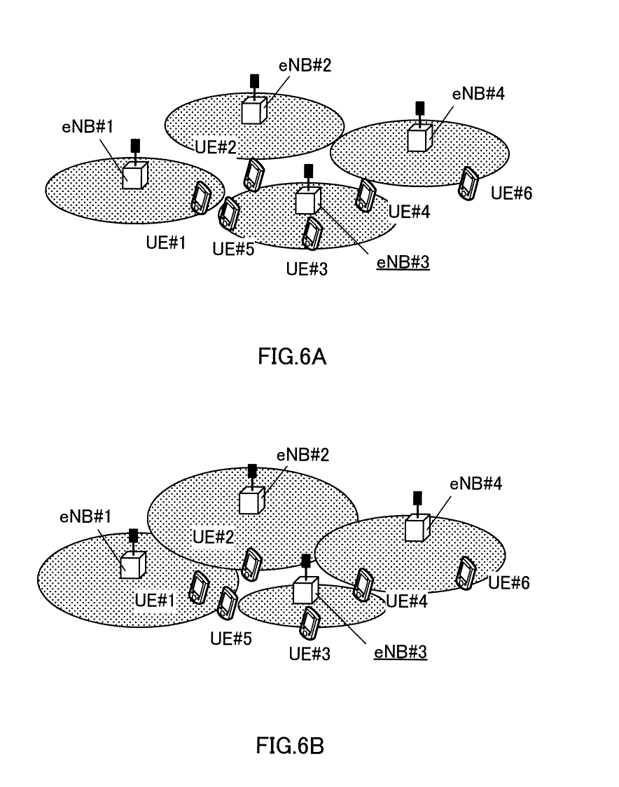

The macro cell base station MeNB controls the tilt angle, the beam direction and the beam width in the antenna beam pattern of each small cell base station SeNB based on the RSRP (RSRQ) and the number of user terminals (buffer size and so on). In the example shown in FIG. 6A, the traffic is concentrated in radio base station eNB #3.

Table 1 shows information about the traffic amount in neighbor base stations, information about antenna beam patterns, and so on. By sharing these pieces of information between base stations via backhaul, more adequate beam forming control that takes into account the variation of traffic, the beam patterns of neighbor base stations and so on becomes possible.

TABLE 1

| | | UE | UE | UE | UE | UE | | Beam |
|---|---|---|---|---|---|---|---|---|
| | UE #1 | #2 | #3 | #4 | #5 | #6 | Tilting | direction/width |
| eNB | x | x | | | x | | Down | Omni |
| #1 | | | | | | | | |
| eNB | | x | | | | | Down | Omni |
| #2 | | | | | | | | |
| eNB | x | x | x | x | x | | Up | 270 deg/ |
| #3 | | | | | | | | 120 deg |
| eNB | | | | x | | x | Down | Omni |
| #4 | | | | | | | | |

In table 1, the bold letter x represents the serving cell.

As shown in table 1, the macro cell base station MeNB applies control so that the tilt angle in the antenna beam pattern for a small cell base station SeNB (radio base station eNB #3) where the traffic amount is large is increased, and the tilt angles in the antenna beam patterns for neighbor small cell base stations SeNB (radio base stations eNB #1, #2 and #4) where the traffic amount is small are reduced. By this means, it is possible to allow the traffic to flow into neighbor cells of radio base station eNB #3 (see FIG. 6B).

To “increase the tilt angle” means making the tilt angle bigger—for example, from 20° to 30°. To “reduce the tilt angle” means making the tilt angle smaller—for example, from 20° to 10°.

Shown in table 1, the information of the tilt angle—“Down” or “Up”—is equivalent to the above-mentioned varying values of the tilt angle information included in the antenna tilt information. Also, the macro cell base station MeNB may report the absolute value of the tilt angle information to each small cell base station SeNB.

Also, as shown in table 1, the macro cell base station MeNB may control the beam direction and the beam width in the antenna beam pattern for a small cell base station SeNB (radio base station eNB #3) where the traffic amount is large to be 270 degrees and 120 degrees, respectively, and control the beam directions and the beam widths in the antenna beam patterns for neighbor small cell base stations SeNB (radio base stations eNB #1, #2 and #4) where the traffic amount is small to be omni-directional.

Shown in table 1, the information of the beam direction and the information of the beam width are equivalent to the absolute value of the angle information regarding the orientation of beams and the absolute value of the angle information regarding the beam width, respectively, included in the above-described information about the horizontal beam.

(Second Control Method)

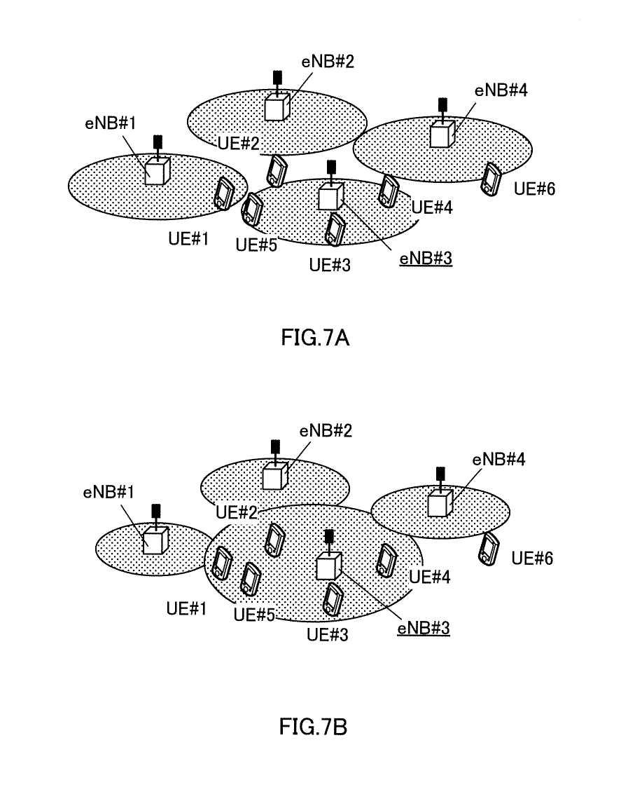

The macro cell base station MeNB controls the tilt angle, the beam direction and the beam width in the antenna beam pattern of each small cell base station SeNB based on the RSRP(RSRQ) and the number of user terminals (buffer size and so on). In the example shown in FIG. 7A, the traffic is concentrated in radio base station eNB #3.

Table 2 shows information about the traffic amount in neighbor base stations, information about antenna beam patterns, and so on. By sharing these pieces of information between base stations via backhaul, more adequate beam forming control that takes into account the variation of traffic, the beam patterns of neighbor base stations and so on becomes possible.

TABLE 2

| | | UE | UE | UE | UE | UE | | Beam |
|---|---|---|---|---|---|---|---|---|
| | UE #1 | #2 | #3 | #4 | #5 | #6 | Tilting | direction/width |
| eNB | x | x | | | x | | Up | Omni |
| #1 | | | | | | | | |
| eNB | | x | | | | | Up | Omni |
| #2 | | | | | | | | |
| eNB | x | x | x | x | x | | Down | 270 deg/ |
| #3 | | | | | | | | 120 deg |
| eNB | | | | x | | x | Up | Omni |
| #4 | | | | | | | | |

In table 2, the bold letter x represents the serving cell.

As shown in table 2, the macro cell base station MeNB applies control so that the tilt angle in the antenna beam pattern for a small cell base station SeNB (radio base station eNB #3) where the traffic amount is large is reduced, and the tilt angles in the antenna beam patterns for neighbor small cell base stations SeNB (radio base stations eNB #1, #2 and #4) where the traffic amount is small are increased. By this means, it is possible to reduce interference and improve the SINR (Signal-to-Interference plus Noise power Ratio) and throughput in high-traffic areas (see FIG. 7B).

(Third Control Method)

The macro cell base station MeNB may specify the locations of user terminal groups based on the RSRP (RSRQ), the number of user terminals (buffer size and so on) and location information (timing advance types 1 and 2, and so on), and control the tilt angle, the beam direction and the beam width in the antenna beam pattern of each small cell base station SeNB.

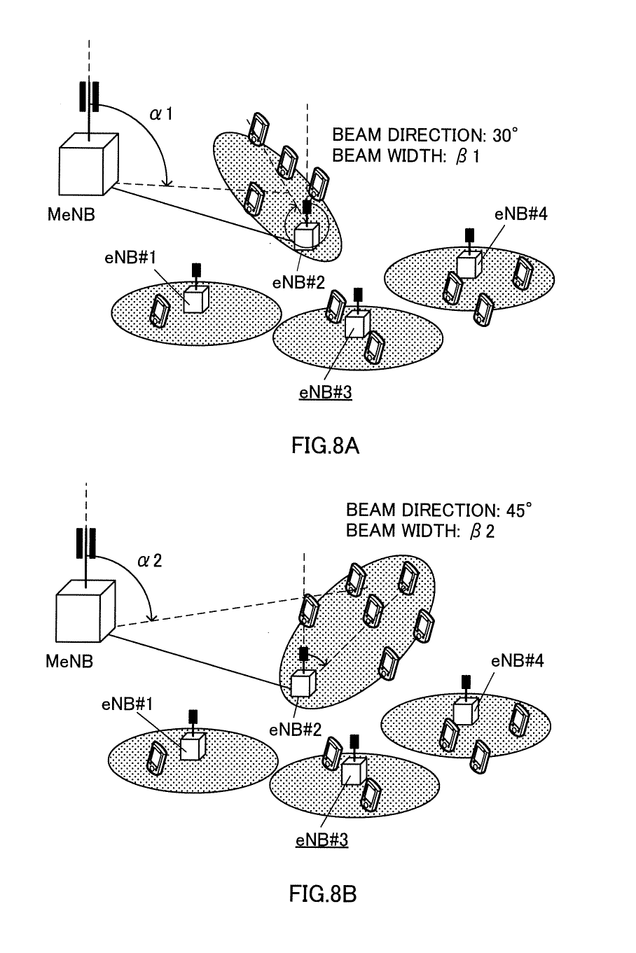

In the example shown in FIG. 8A, the macro cell base station MeNB specifies the location of a user terminal group, and controls the tilt angle, the beam direction and the beam width in the antenna beam pattern for radio base station eNB #2, which is a small cell base station.

In the example shown in FIG. 8B, the location of the user terminal group has changed from the example shown in FIG. 8A. The macro cell base station MeNB specifies the location of the user terminal group, and controls the tilt angle, the beam direction and the beam width in the antenna beam pattern for radio base station eNB #2, which is a small cell base station.

The examples of the first control method to the third control method presume communications between a macro cell base station MeNB and small cell base stations SeNB. By contrast with this, it is equally possible to presume communications between radio base stations or between small base stations in single connectivity, where neither carrier aggregation nor dual connectivity is employed, or presume communications between small base stations in the event carrier aggregation and/or dual connectivity are employed.

(Fourth Control Method)

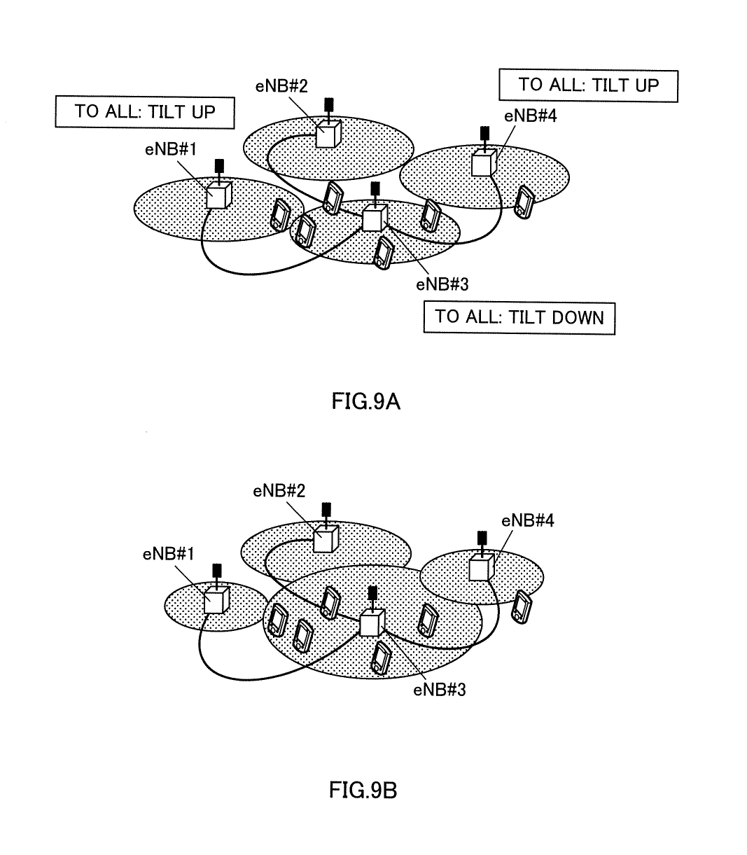

A radio base station eNB may execute autonomous control based on traffic and report the results of control, future operations and so on to every radio base station eNB. In the example shown in FIG. 9A, radio base station eNB #1 reports to each radio base station that the tilt angle in the antenna beam pattern for radio base station eNB #1 increased. Similarly, radio base station eNB #3 reports to each radio base station that the tilt angle in the antenna beam pattern for radio base station eNB #3 is reduced. Radio base station eNB #4 reports to each radio base station that the tilt angle in the antenna beam pattern for radio base station eNB #4 is increased.

In this way, by means of control based on information about neighbor antenna beam patterns, it is possible to reduce interference and improve the SINR and throughput in high-traffic areas (see FIG. 9B).

(Fifth Control Method)

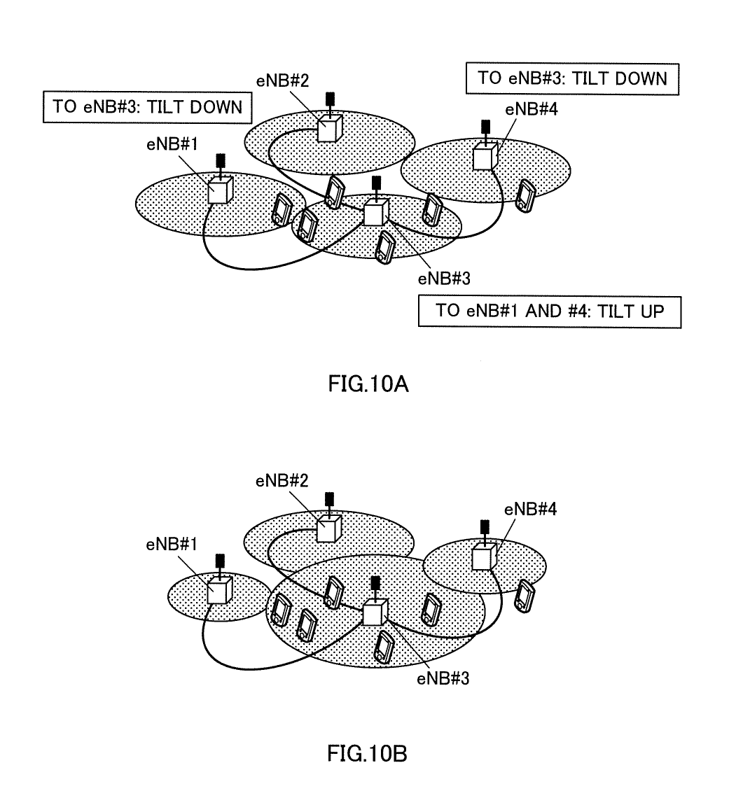

A radio base station eNB may execute autonomous control based on traffic and reports to each radio base station what control is desirable. In the example shown in FIG. 10, radio base stations eNB #1 and #4 report to radio base station eNB #3 to apply control so as to reduce the tilt angle of its antenna beam pattern. Radio base station eNB #3 reports to radio base stations eNB #1 and #4 to apply control so as to reduce the tilt angles of their antenna beam patterns.

By means of this control, it is possible to reduce interference and improve the SINR and throughput in high-traffic areas (see FIG. 10B).

As described above, by sharing information about the traffic amount in neighbor base stations, information about antenna beam patterns and so on between base stations via backhaul, beam forming control in accordance with traffic is made possible, so that improved throughput can be achieved.

(Structure of Radio Communication System)

Now, the structure of the radio communication system according to the present embodiment will be described below. In this radio communication system, the above-described radio communication methods to execute beam forming control are employed.

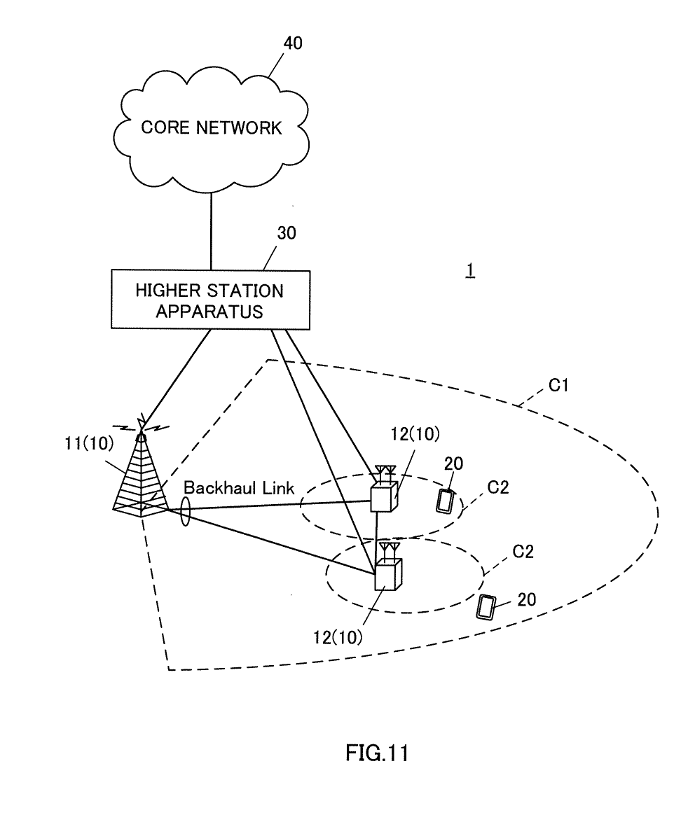

FIG. 11 is a schematic structure diagram to show an example of the radio communication system according to the present embodiment. As shown in FIG. 11, a radio communication system 1 is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30, and are connected to a core network 40 via the higher station apparatus 30.

In FIG. 11, the radio base station 11 is, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 11.

In the macro cell C1 and the small cells C2, the same frequency band may be used, or different frequency bands may be used. Also, the macro base stations 11 and 12 are connected with each other via an inter-base station interface (for example, optical fiber, the X2 interface, etc.).

Between the radio base station 11 and the radio base stations 12, between the radio base station 11 and other radio base stations 11, or between the radio base stations 12 and other radio base stations 12, dual connectivity (DC) or carrier aggregation (CA) is employed.

User terminals 20 are terminals to support various communication schemes such as LTE, LTE-A and so on, and may include both mobile communication terminals and stationary communication terminals. The user terminals 20 can communicate with other user terminals 20 via the radio base stations 10.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared CHannel), which is used by each user terminal 20 on a shared basis, a downlink control channel (PDCCH (Physical Downlink Control CHannel), EPDCCH (Enhanced Physical Downlink Control CHannel), etc.), a broadcast channel (PBCH) and so on are used as downlink channels. User data, higher layer control information and predetermined SIBs (System Information Blocks) are communicated in the PDSCH. Downlink control information (DCI) is communicated by the PDCCH and the EPDCCH.

Also, in the radio communication system 1, an uplink shared channel (PUSCH: Physical Uplink Shared CHannel), which is used by each user terminal 20 on a shared basis, an uplink control channel (PUCCH: Physical Uplink Control CHannel) and so on are used as uplink channels. User data and higher layer control information are communicated by the PUSCH.

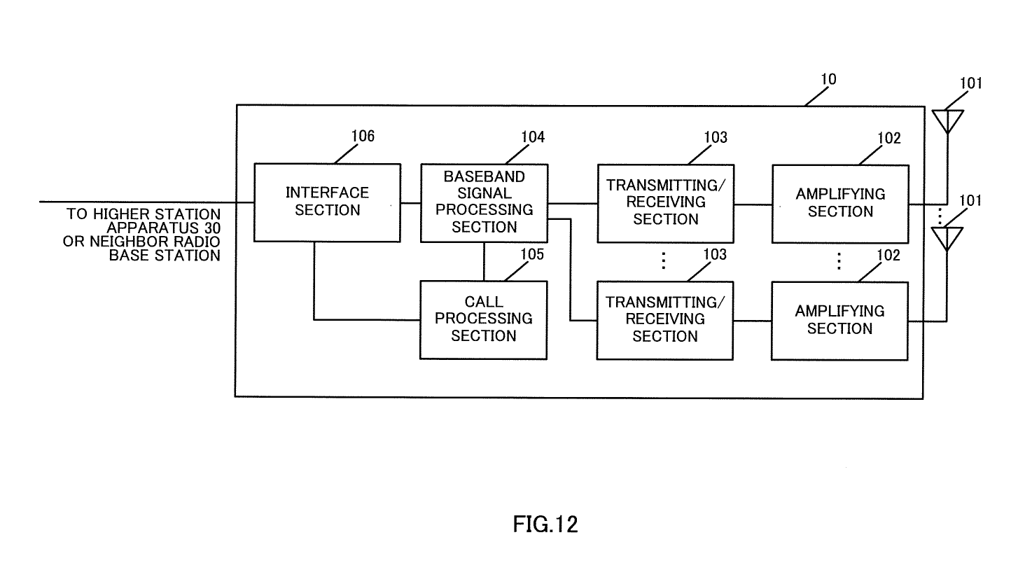

FIG. 12 is a diagram to show an overall structure of a radio base station 10 according to the present embodiment. As shown in FIG. 12, the radio base station 10 has a plurality of transmitting/receiving antennas 101 for MIMO communication, amplifying sections 102, transmitting/receiving section (a transmitting section and a receiving section) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. For the transmitting/receiving sections 103, transmitters/receivers, transmitting/receiving circuits or transmitting/receiving devices that can be described based on common understanding of the technical field to which the present invention pertains can be employed.

On the other hand, as for the uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

The transmitting/receiving sections 103 transmit and receive control signals pertaining to adaptive area control between base stations through backhaul signaling. The transmitting/receiving sections 103 receive measurement reports transmitted from the user terminals 10.

In the baseband signal processing section 104, the user data that is included in the input uplink signals is subjected to an FFT process, an IDFT process, error correction decoding, a MAC retransmission control receiving process and RLC layer and PDCP layer receiving processes, and the result is forwarded to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighbor radio base stations (backhaul signaling) via an inter-base station interface (for example, optical fiber, the X2 interface, etc.). Alternatively, the interface section 106 transmits and receives signals to and from the higher station apparatus 30 via a predetermined interface.

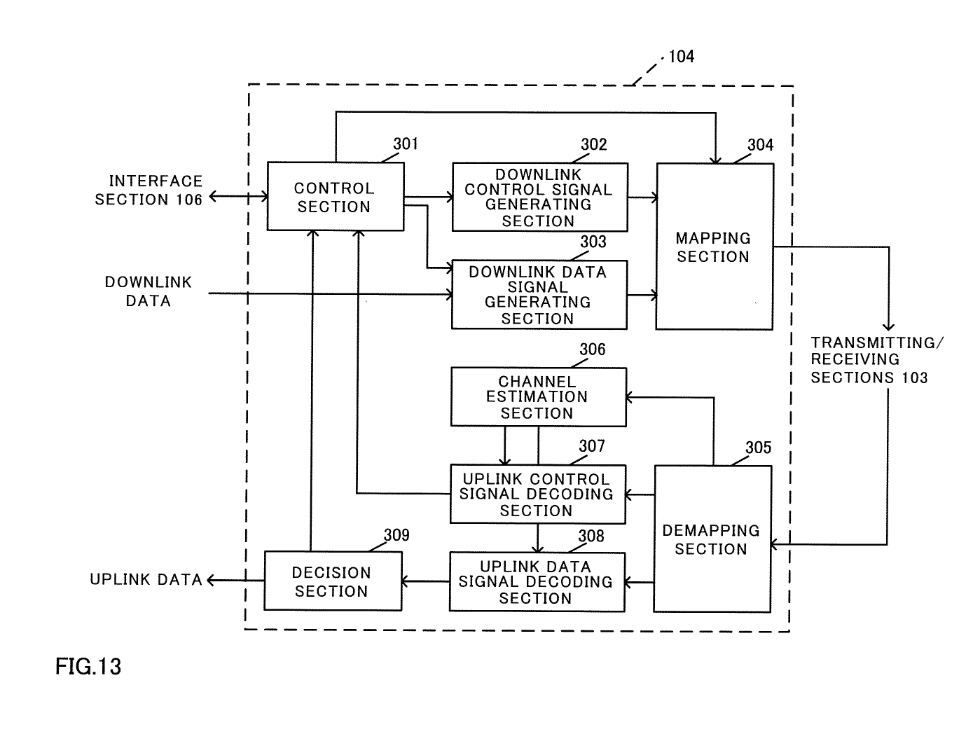

FIG. 13 is a diagram to show a principle functional structure of the baseband signal processing section 104 provided in the radio base station 10 according to the present embodiment. As shown in FIG. 13, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308 and a decision section 309.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling of RA preambles communicated in the PRACH, uplink data that is communicated in the PUSCH, uplink control information that is communicated in the PUCCH or the PUSCH, and uplink reference signals (allocation control). Information about the allocation control of uplink signals (uplink control signals, uplink user data, etc.) is reported to the user terminals 20 by using a downlink control signal (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be employed.

Based on the traffic information and the antenna beam forming-related information of neighbor radio base stations and the radio base station 10 included in the control signals, the control section 301 controls the antenna beam pattern of one or both of the neighbor radio base stations and the radio base station 10.

The downlink control signal generating section 302 generates downlink control signals (which may be both PDCCH signals and EPDCCH signals, or may be one of these) that are determined to be allocated by the control section 301. To be more specific, the downlink control signal generating section 302 generates downlink assignments, which report downlink signal allocation information, and uplink grants, which report uplink signal allocation information, based on commands from the control section 301. For the downlink control signal generating section 302, a signal generator or a signal generating circuit that can be described based on common understanding of the technical field to which the present invention pertains can be employed.

The downlink data signal generating section 303 generates downlink data signals (PDSCH signals) that are determined to be allocated to resources by the control section 301. The data signals that are generated in the data signal generating section 303 are subjected to a coding process and a modulation process, based on coding rates and modulation schemes that are determined based on CSI from each user terminal 20 and so on.

The mapping section 304 controls the allocation of the downlink control signals generated in the downlink control signal generating section 302 and the downlink data signals generated in the downlink data signal generating section 303 to radio resources based on commands from the control section 301. For the mapping section 304, a mapping circuit or a mapper that can be described based on common understanding of the technical field to which the present invention pertains can be employed.

The demapping section 305 demaps the uplink signals transmitted from the user terminals 20 and separates the uplink signals. The channel estimation section 306 estimates channel states from the reference signals included in the received signals separated in the demapping section 305, and outputs the estimated channel states to the uplink control signal decoding section 307 and the uplink data signal decoding section 308.

The uplink control signal decoding section 307 decodes the feedback signals (delivery acknowledgement signals and/or the like) transmitted from the user terminals in the uplink control channel (PRACH, PUCCH, etc.), and outputs the results to the control section 301. The uplink data signal decoding section 308 decodes the uplink data signals transmitted from the user terminals through an uplink shared channel (PUSCH), and outputs the results to the decision section 309. The decision section 309 makes retransmission control decisions (A/N decisions) based on the decoding results in the uplink data signal decoding section 308, and outputs results to the control section 301.

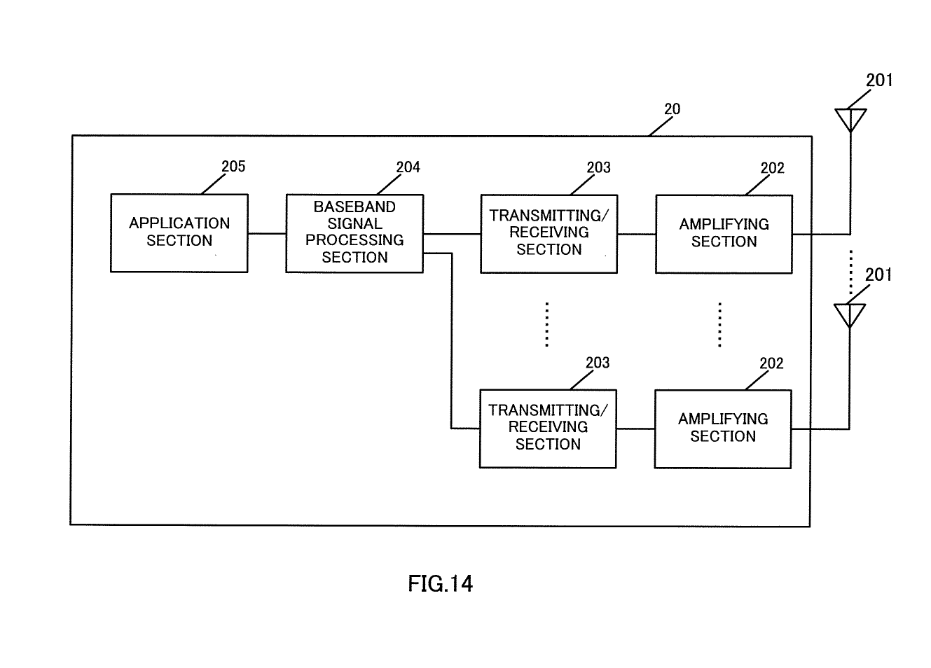

FIG. 14 is a diagram to show an overall structure of a user terminal 20 according to the present embodiment. As shown in FIG. 14, the user terminal 20 has a plurality of transmitting/receiving antennas 201 for MIMO communication, amplifying sections 202, transmitting/receiving sections (transmitting section and receiving section) 203, a baseband signal processing section 204 and an application section 205.

As for downlink data, radio frequency signals that are received in a plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving sections 203, transmitters/receivers, transmitting/receiving circuits or transmitting/receiving devices that can be described based on common understanding of the technical field to which the present invention pertains can be employed.

Meanwhile, uplink user data is input from the application section 205 to the baseband signal processing section 204. In the baseband signal processing section 204, a retransmission control (HARQ: Hybrid ARQ) transmission process, channel coding, precoding, a DFT process, an IFFT process and so on are performed, and the result is forwarded to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and transmit the resulting signal from the transmitting/receiving antennas 201.

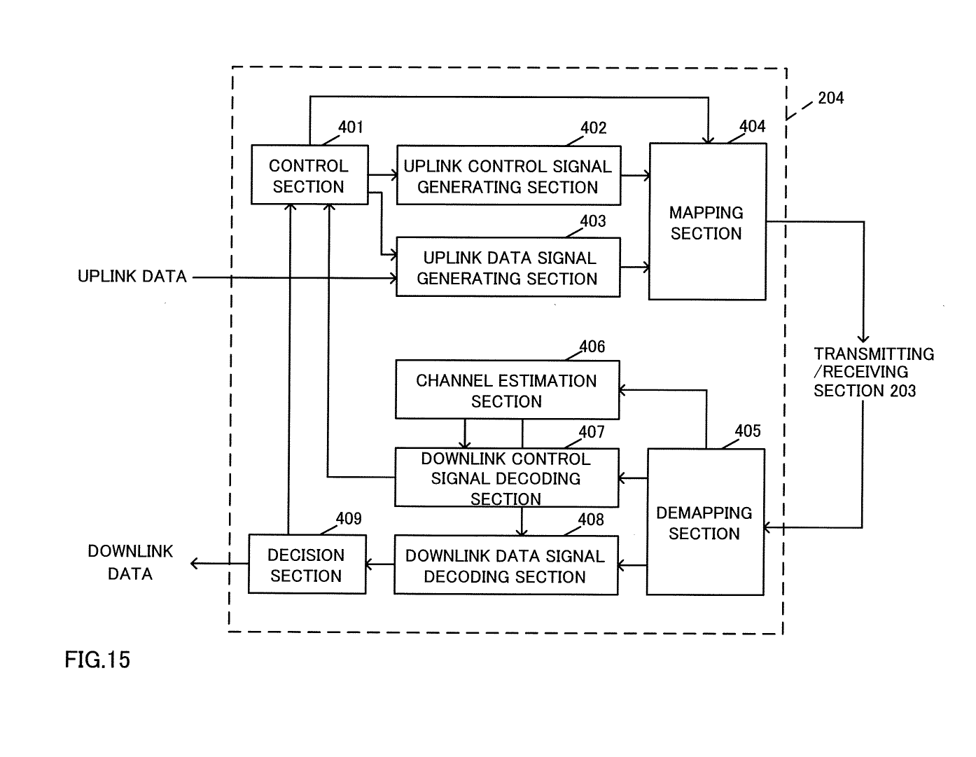

FIG. 15 is a diagram to show a principle functional structure of the baseband signal processing section 204 provided in the user terminal 20. As shown in FIG. 15, the baseband signal processing section 204 provided in the user terminal 20 is comprised at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.), uplink data signals and so on, based on the downlink control signals (PDCCH signals) transmitted from the radio base stations 10, retransmission control decisions in response to the PDSCH signals received, and so on. The downlink control signals received from the radio base stations are output from the downlink control signal decoding section 408, and the retransmission control decisions are output from the decision section 409. For the control section 401, a controller or a control device that can be described based on common understanding of the technical field to which the present invention pertains can be employed.

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when an uplink grant is contained in a downlink control signal reported from a radio base station, the control section 401 commands the uplink data signal 403 to generate an uplink data signal. For the uplink control signal generating section 402, a signal generator or a signal generating circuit that can be described based on common understanding of the technical field to which the present invention pertains can be employed.

The mapping section 404 controls the allocation of the uplink control signals (delivery acknowledgment signals and so on) and the uplink data signals to radio resources (PUCCH, PUSCH, etc.) based on commands from the control section 401.

The demapping section 405 demaps the downlink signals transmitted from the radio base station 10 and separates the downlink signals. The channel estimation section 407 estimates channel states from the reference signals included in the received signals separated in the demapping section 406, and outputs the estimated channel states to the downlink control signal decoding section 407 and the downlink data signal decoding section 408.

The downlink control signal decoding section 407 decodes the downlink control signal (PDCCH signal) transmitted in the downlink control channel (PDCCH), and outputs the scheduling information (information regarding the allocation to uplink resources) to the control section 401. Also, when information related to the cell to feed back delivery acknowledgement signals or information as to whether or not to apply RF tuning is included in a downlink control signal, these pieces of information are also output to the control section 401.

The downlink data signal decoding section 408 decodes the downlink data signals transmitted in the downlink shared channel (PDSCH), and outputs the results to the decision section 409. The decision section 409 makes retransmission control decisions (A/N decisions) based on the decoding results in the downlink data signal decoding section 408, and outputs the results to the control section 401.

Note that the present invention is by no means limited to the above embodiment and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2014-149889, filed on Jul. 23, 2014, including the specification, drawings and abstract, is incorporated herein by reference in its entirety.

1. A radio base station that can exchange control information with a neighbor radio base station via backhaul, the radio base station comprising:
a transmitting/receiving section that transmits and receives the control information through backhaul signaling; and
a control section that controls an antenna beam pattern of one or both of the neighbor radio base station and the radio base station based on traffic information and information about antenna beam forming for the neighbor radio base station and the radio base station, which are included in the control information.

2. The radio base station according to claim 1, wherein the control information includes information about antenna tilt and a horizontal beam.

3. The radio base station according to claim 1, wherein the control information includes information about one of antenna tilt, a horizontal beam, transmission power, an antenna pattern, a rate of use of resources, and an average throughput value.

4. The radio base station according to claim 1, wherein the control section increases a tilt angle in an antenna beam pattern for a radio base station where traffic amount is large, and reduces the tilt angle in an antenna beam pattern for a radio base station where the traffic amount is small.

5. The radio base station according to claim 1, wherein the control section reduces a tilt angle in an antenna beam pattern for a radio base station where traffic amount is large, and increases the tilt angle in an antenna beam pattern for a radio base station where the traffic amount is small.

6. The radio base station according to claim 1, wherein:
the traffic information includes a number of user terminals and location information of the user terminals; and
the control section specifies the location of a user terminal group and controls a tilt angle, a beam direction and a beam width in the antenna beam pattern of each radio base station.

7. The radio base station according to claim 1, wherein the radio base station comprising the control section is a macro cell base station, and the macro cell base station controls the antenna beam pattern of each small cell base station.

8. The radio base station according to claim 1, wherein:
the control section controls the antenna beam pattern of the radio base station; and
the transmitting/receiving section reports a result of the control to the neighbor radio base station.

9. The radio base station according to claim 1, wherein:
the control section controls antenna beam pattern of the neighbor radio base station; and
the transmitting/receiving section reports the control result to the neighbor radio base station.

10. A radio communication method for a radio base station that can exchange control information with a neighbor radio base station via backhaul, the radio communication method comprising the steps of:
transmitting and receiving the control information through backhaul signaling; and
controlling an antenna beam pattern of one or both of the neighbor radio base station and the radio base station based on traffic information and information about antenna beam forming for the neighbor radio base station and the radio base station, which are included in the control information.

11. The radio base station according to claim 2, wherein the radio base station comprising the control section is a macro cell base station, and the macro cell base station controls the antenna beam pattern of each small cell base station.

12. The radio base station according to claim 3, wherein the radio base station comprising the control section is a macro cell base station, and the macro cell base station controls the antenna beam pattern of each small cell base station.

13. The radio base station according to claim 4, wherein the radio base station comprising the control section is a macro cell base station, and the macro cell base station controls the antenna beam pattern of each small cell base station.

14. The radio base station according to claim 5, wherein the radio base station comprising the control section is a macro cell base station, and the macro cell base station controls the antenna beam pattern of each small cell base station.

15. The radio base station according to claim 6, wherein the radio base station comprising the control section is a macro cell base station, and the macro cell base station controls the antenna beam pattern of each small cell base station.
